(19) United States
(12) Patent Application Publication
(10) Pub. No.: US 2015/0220571 A1
(43) Pub. Date: Aug. 6, 2015

(54) PIPELINED RE-SHUFFLING FOR DISTRIBUTED COLUMN STORE

(71) Applicant: Futurewei Technologies, Inc., Plano, TX (US)

(72) Inventors: Chi Young Ku, San Ramon, CA (US); Mengmeng Chen, San Jose, CA (US); Ron-Chung Hu, Palo Alto, CA (US); Masood Mortazavi, San Jose, CA (US); Fang Cao, San Jose, CA (US)

(21) Appl. No.: 14/610,574

(22) Filed: Jan. 30, 2015

Related U.S. Application Data
(60) Provisional application No. 61/934,356, filed on Jan. 31, 2014.

(51) Int. Cl. G06F 17/30

(52) U.S. Cl. CPC G06F 17/30289; G06F 17/30595

(57) ABSTRACT

A method of pipelining re-shuffled data of a distributed column oriented relational database management system (RDBMS). A request is received from a consumer process that requires RDBMS column data to be shuffled in a specific order according to an order that each of a plurality of columns will be used by the consumer process. For each of the plurality of columns, the method re-shuffles the RDBMS column data according to the specific order to form re-shuffled RDBMS column data, and sends the re-shuffled RDBMS column data to the consumer process.

### CLAIM OF PRIORITY

This application claims priority of U.S. Provisional Patent Application Ser. No. 61/934,356, filed on Jan. 31, 2014, entitled “PIPELINED RE-SHUFFLING FOR DISTRIBUTED COLUMN STORE” the teachings which are incorporated herein by reference.

### TECHNICAL FIELD

This disclosure is directed to Relational Database Management Systems (RDBMSs) and re-shuffling data.

### BACKGROUND

Relational Database Management Systems (RDBMSs) for decision support have evolved from row oriented storage and processing to column oriented storage and processing. Distributed row oriented RDBMSs typically employ pipelined re-shuffling to reduce materialization of intermediate results. In distributed row oriented RDBMSs, all columns of a row are re-shuffled at the same time. Distributed column oriented RDBMSs are at the forefront of current database technology. Distributed column oriented RDBMSs typically employ blocking re-shuffling schemes that materializes intermediate results.

Distributed column oriented RDBMSs, also referred to as distributed column stores, have a major cost of materializing intermediate results of a re-shuffle, creating a lot of input/output (I/O) traffic between consumers and producers of the data of distributed column oriented RDBMSs.

### SUMMARY

The present disclosure provides a system and method for pipelined re-shuffling of column data for a distributed column store.

In a first example embodiment of the disclosure, a method for pipelined re-shuffling data of a distributed column oriented relational database management system (RDBMS) comprises receiving a request from a consumer process that requires RDBMS column data to be shuffled in a specific order according to an order that each of a plurality of columns will be used by the consumer process. For each of the plurality of columns, the method re-shuffles the RDBMS column data according to the specific order to form re-shuffled RDBMS column data, and sends the re-shuffled RDBMS column data to the consumer process.

In some embodiments, the step of re-shuffling the RDBMS column may be one at a time according to a sequence they are needed by the consumer process. The intermediate data may not be materialized before being used by the consumer process. The columns may be distributed across one or more servers. The column data of the plurality of columns may include one or more different types and categories. The column data may include strings of names, integer identifiers, and floating point numerical data.

In another embodiment, a method of communicating between a parallel consumer process and a parallel producer process of a distributed column oriented relational database management system (RDBMS) comprises the parallel consumer process receiving a column operator that operates over one or more columns of RDBMS column data. The parallel consumer process sends a request to the parallel producer process for columns required by the column operator, wherein the request includes an order that the columns are present in the column operator. The parallel producer process processes the request by retrieving the columns from the RDMBS and shuffling the columns in the order that the columns are present in the column operator. The parallel producer process transmits the columns that have been shuffled according to the order of the column operator, and the parallel consumer process receives the shuffled columns.

In some embodiments, the parallel consumer process executes column operators and consumes the column data of the shuffled columns produced by the parallel producer process. The request may require a first column prior to a second column, wherein the parallel producer process shuffles the column data of the first column retrieved from the distributed column oriented RDBMS, and then reshuffles the column data again via the second column. The intermediate data may not be materialized before being consumed by the parallel consumer process. The columns may be distributed across one or more servers, and the column data of the columns may include one or more different types and categories. The column data may include strings of names, integer identifiers, and floating point numerical data.

In another embodiment, a distributed column oriented relational database management system (RDBMS) comprises a parallel consumer process configured to receive a column operator that operates over one or more columns of RDBMS column data, and send a request indicating columns required by the column operator, wherein the request includes an order that the columns are present in the column operator. A parallel producer process is configured to receive the request and retrieve the columns and shuffle the columns in the order that the columns are present in the column operator, and transmit the columns to the parallel consumer process that have been shuffled according to the order of the column operator.

In some embodiments, the parallel consumer process is configured to consume the column data of the shuffled columns produced by the parallel producer process. The request identifies a first column required prior to a second column, wherein the parallel producer process is configured to shuffle the retrieved column data of the first column, and then reshuffle the column data again via the second column. The intermediate data is not materialized before being consumed by the parallel consumer process. The columns may be distributed across one or more servers. The column data of the columns includes one or more different types and categories. The column data includes strings of names, integer identifiers, and floating point numerical data.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a column oriented database system where columns are stitched together first before they are re-shuffled to different nodes for join operation;

FIG. 2 illustrates the query execution plan for a query;

FIG. 3 illustrates a sequence of shuffling columns according to this disclosure;

FIG. 4 illustrates how operations can be overlapped to maximize the pipeline operation;

FIG. 5 illustrates a server according to this disclosure;

FIG. 6 illustrates a distributed column oriented RDBMS;

FIG. 7 illustrates communication between consumer and producer processes of an RDBMS;

FIG. 8 illustrates a message flow diagram between consumer processes, scheduler processes, and producer processes to reshuffle data of a distributed column oriented RDBMS; and

FIG. 9 illustrates a logical diagram of a parallel/distributed shared-nothing architecture according to this disclosure.

### DETAILED DESCRIPTION

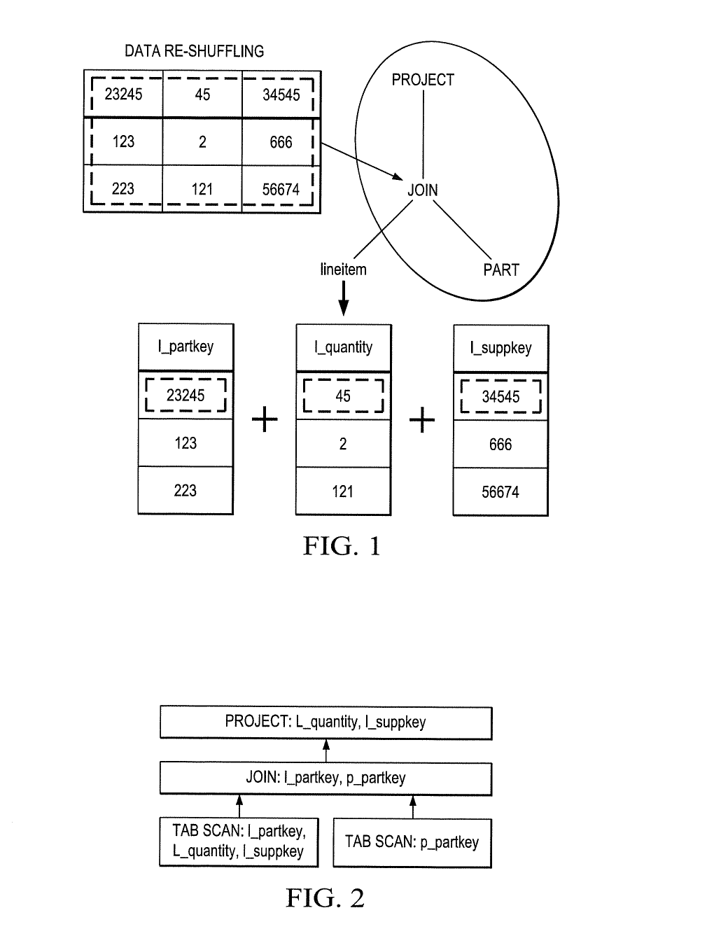

FIGS. 1 through 9, discussed below, and the various embodiments used to describe the principles of the present invention in this patent document are by way of illustration only and should not be construed in any way to limit the scope of the invention. Those skilled in the art will understand that the principles of the invention may be implemented in any type of suitably arranged device or system.

Data re-shuffling consumes a significant portion of the overall resources used in distributed query processing of RDBMSs. One of the major cost components of data re-shuffling is materializing the intermediate results, as is the case with blocking re-shuffling schemes used for column oriented RDBMSs. Pipelined re-shuffling reduces the materialization cost to a minimum, which is shown in the superior performance of parallel RDBMSs relative to systems that utilize map and reduce (MapReduce) oriented query processing. However, distributed column oriented RDBMSs create unique challenges for implementing pipelined re-shuffling in that columns need to be re-shuffled one at a time according to the sequence they are needed by the consumer of the data.

To apply pipelined re-shuffling to distributed column oriented RDBMSs, the columns need to be re-shuffled one at a time in the order that the columns are needed by a consumer of the columns. This is different from how pipelined re-shuffling is applied to row oriented distributed RDBMSs. With row oriented distributed RDBMSs, all columns of a row are re-shuffled at the same time. Pipelined re-shuffling is also different from blocking re-shuffling schemes because, unlike pipelined re-shuffling of distributed column oriented RDBMS columns, blocking re-shuffling schemes require an intermediate data materialization step for each column that is to be shuffled. As compared to blocking re-shuffling schemes, pipelined re-shuffling reduces input/output (I/O) costs by reducing the steps of intermediate data materialization for each column being re-shuffled.

According to this disclosure, a pair of parallel processes, a producer parallel process and a consumer parallel process, function to process data in a column oriented distributed RDBMS that is pipeline re-shuffled. While the consumer parallel process executes one or more column operators one at a time, the producer parallel process re-shuffles the columns needed by the consumer column operators one at a time according to the order in which these operators are executed, and according to the order in which operands of each operator are fetched. The pipelined re-shuffling of column oriented RDBMS data is different from pipelined re-shuffling for distributed row oriented RDBMSs in that, with pipelined re-shuffling of column oriented RDBMS data, the columns are re-shuffled one at a time according to the sequence they are needed on the consumer side. The pipelined re-shuffling of column oriented RDBMS data is also different from blocking re-shuffling used by distributed column oriented RDBMSs in that intermediate data is not materialized before being used.

Pipelined re-shuffling of column oriented RDBMS data reduces the cost of re-shuffling in a distributed column oriented RDBMS by 20%-50%. Assuming that re-shuffling takes about 20%-30% of total resources, embodiments according to this disclosure can improve distributed query processing efficiency by 4%-15%.

To illustrate this disclosure, the following query is processed:

SELECT l_quantity, l_suppkey

FROM lineitem, part

WHERE l_partkey=p_partkey;

On a clustered system with multiple nodes, suppose the part table is partitioned on the column p_partkey which is the join column for the above query. Also suppose the lineitem table is partitioned on l_orderkey column which is different from the join column. For conventional column oriented database systems, all the relevant columns are stitched together first before they are re-shuffled to different nodes for the join operation, as shown in FIG. 1.

For distributed column-oriented RDBMS, instead of stitching all fields of each row together before pipelined re-shuffling, the columns are re-shuffled one at a time in the order they are needed on the consumer side. The ordering of consumption of all the columns is determined by the operator in the execution plan. For example, FIG. 2 shows the query execution plan for the above query.

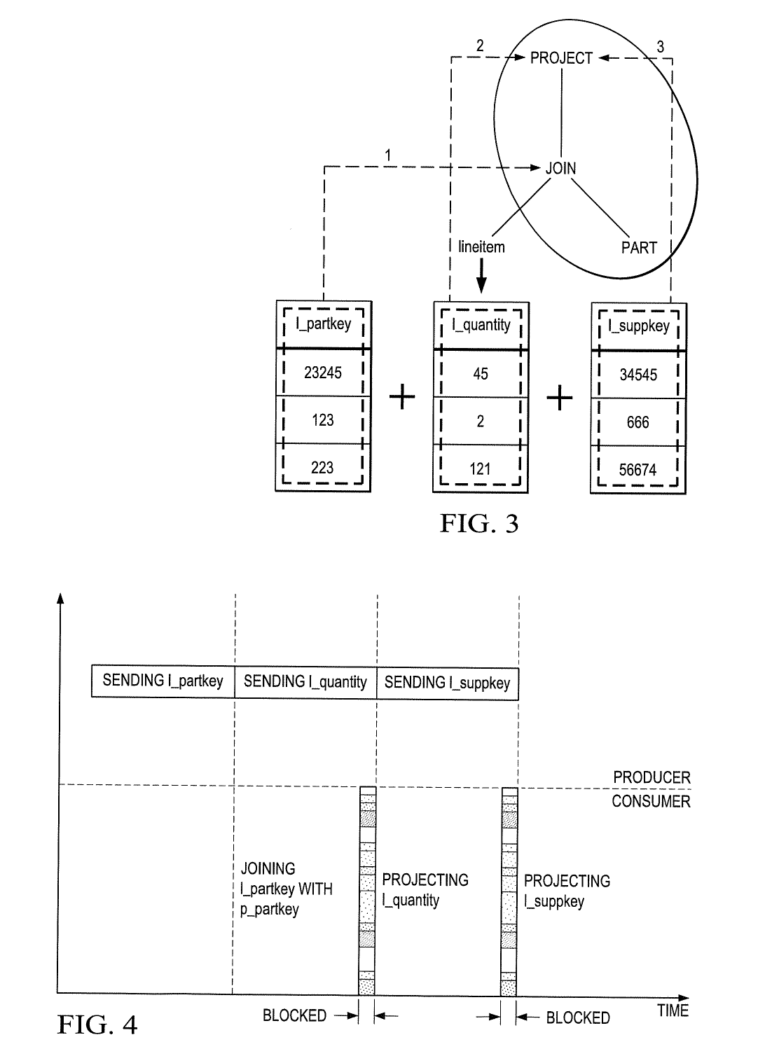

In the query execution plan shown in FIG. 2, the table scan operation takes place first, followed by the join operation, and then followed by the projection operation. In this disclosure, the columns are not stitched together. Instead, the columns are shuffled one by one based on the operation specified in the query plan. The opportunity to pipeline the join operation and the projection operation is maximized. FIG. 3 illustrates the sequence of shuffling columns according to this disclosure.

The net effect is to overlap the three operations together, namely, the shuffling operation, the join operation, and the projection operation, hence further reducing the query response time. FIG. 4 illustrates how these operations can be overlapped to maximize the pipeline operation.

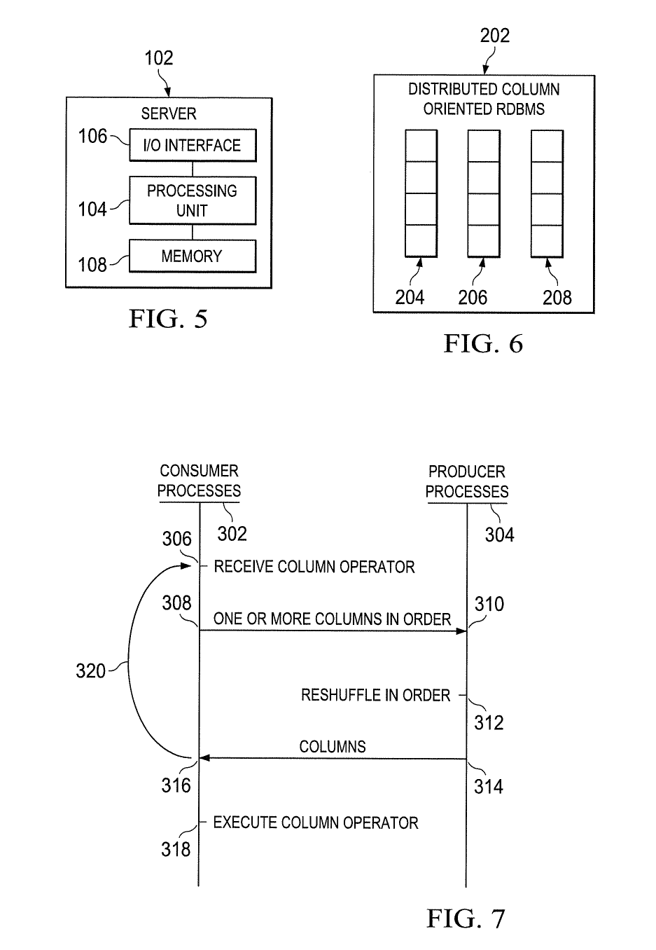

FIG. 5 illustrates a server according to this disclosure. Server 102 includes one or more processing units 104, one or more input/output interfaces 106, and one or more memories 108. Server 102 can be distributed over one or more physical servers and virtual servers.

Each processing unit 104 implements various processing operations of the server 102, such as signal coding, data processing, power control, input/output processing, or any other functionality. Each processing unit 104 can also support the methods and teachings described in more detail herein. Each processing unit 104 includes any suitable processing or computing device configured to perform one or more operations, including operations for pipelined re-shuffling of data of distributed column oriented RDBMSs. Each processing unit 104 could, for example, include a microprocessor, microcontroller, digital signal processor, field programmable gate array, or application specific integrated circuit.

The server 102 further includes one or more input/output interfaces 106. The input/output interfaces 106 facilitate communication with other devices, such as other servers or client devices. Each input/output interfaces 106 could, for example, include one or more ports for wired, wireless, or optical communication with point to point addressing such as Ethernet in its various realizations.

The server 102 includes one or more memories 108. Each memory 108 stores instructions and data used, generated, or collected by the server 102 and one or more databases, such as a column oriented RDBMS. For example, each memory 108 could store software or firmware instructions executed by the processing unit(s) 104 and data of a distributed column oriented RDBMS. Each memory 108 includes any suitable volatile and/or non-volatile storage and retrieval device(s). Any suitable type of memory may be used, such as random access memory (RAM), read only memory (ROM), hard disk, optical disc, memory stick, secure digital (SD) memory card, and so on.

FIG. 6 illustrates a distributed column oriented RDBMS. The distributed column oriented RDBMS 202 includes one or more columns, including columns 204-208. The RDBMS 202 and one or more of the columns 204-208 can be distributed across one or more servers, such as server 102 of FIG. 5. The distributed column oriented RDBMS 202 stores data column by column, with the columns including one or more different types and categories. For example, the column 204 can include strings of names, the column 206 can include integer identifiers, the column 208 can include floating point numerical data, and so forth.

FIG. 7 illustrates a method for communication between consumer and producer processes of an RDBMS according to this disclosure. One or more parallel consumer processes 302 communicate with one or more parallel producer processes 304 so that the consumer processes 302 can consume data of a distributed column oriented RDBMS, such as the distributed column oriented RDBMS 202 of FIG. 6, which is produced by the producer processes 304. The consumer processes 302 can reside or be hosted on one or more servers, such as the server 102 of FIG. 5. The producer processes 304 can reside or be hosted on one or more servers, such as the server 102 of FIG. 5.

The consumer processes 302 receive a column operator at 306. The column operator operates over one or more columns of data of the distributed column oriented RDBMS 202. The columns required by the column operator are produced from the distributed column oriented RDBMS 202 and shuffled (or re-shuffled) in the order that the columns are present in the column operator.

At 308, the consumer processes 302 send a request for the columns required by the column operator to the producer processes 304. At 310, the producer processes 304 receive the request for the columns and the order of the columns.

At 312, the producer processes 304 reshuffle columns from the distributed column oriented RDBMS 202 that are requested from the consumer processes 302. For example, when the request requires a first column, such as the column 204 of FIG. 2, prior to a second column, such as column 206, the producer processes 304 reshuffle the data retrieved from the distributed column oriented RDBMS 202 via the first column 204, and then reshuffle the data again via the second column 206.

At 314, the producer processes 304 transmit the columns that have been reshuffled according to the order of the column operator. At 316, the consumer processes 302 receive the columns.

At 318, the consumer processes 302 execute column operators therein consuming the data of the columns produced by the producer processes 304. At 320, the consumer processes 302 repeat and process additional column operators as necessary.

Algorithm:

One algorithm according to an embodiment of this disclosure is as follows.

A query is translated into a syntax tree. The syntax tree is checked for semantic correctness, then transformed into a directed acyclic graph (DAG) of logical relational operators, called a Rel DAG.

The Rel DAG is transformed into a parallel Rel DAG using a depth-first traversal of the Rel DAG to insert Exchange nodes. An Exchange node is inserted when the clustering requirements of a parent Rel is incompatible with the clustering characteristics of the child Rel.

The parallel Rel DAG is transformed into a DAG of functions and re-shuffling actions, called the parallel plan, in the following way:
i. For each fragment of the parallel Rel DAG between 2 adjacent Exchange nodes, generate a function.
ii. For each Exchange node, generate a re-shuffling action.
iii. Each function is transformed into a statement forest. A node in the statement forest represents the computation of an expression given its children. The execution plan for the function is generated by traversing the statement forest in a depth-first manner and generating a list of physical BAT operators for each node. The input of a function is re-shuffled columns' data from the children Exchange nodes. The output of a function is columns' data required by ancestor functions. They become the input to the parent Exchange node.
iv. As the output columns can be materialized in any order, a pair of functions are generated in such way that output columns of the child function are materialized in the same order as they are needed as input by the parent function.
v. At runtime, the parallel execution coordinator makes a depth-first traversal of the parallel plan, executing functions and re-shuffling actions as it visits them.

The execution coordinator executes a parallel plan in the following way:
vi. The parallel plan is first linearized according to depth-first traversal ordering.
vii. Starting from the first triple <function 0, Exchange node 1, function 2>, it schedules function 0 and function 2 to be executed in parallel.
viii. After function 0 finishes, it schedules function 4 to be executed.
ix. This continues until the last function completes.

When function n and function n+2 are executing, the former is the producer and the latter is the consumer and data is re-shuffled via Exchange node n+1.

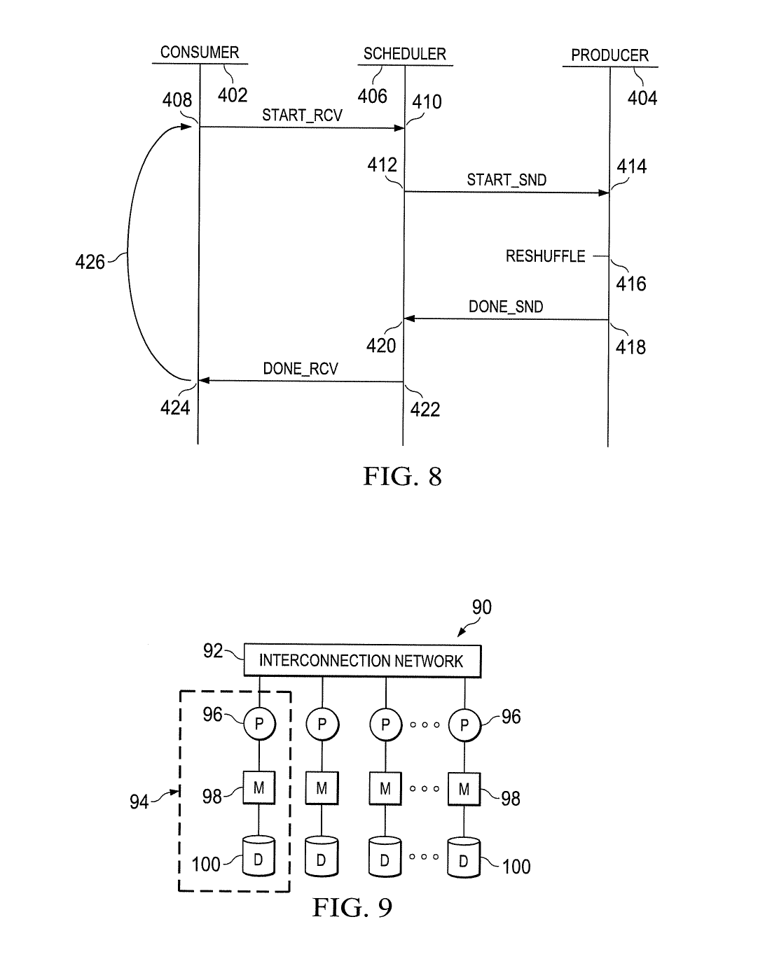

FIG. 8 illustrates a message flow diagram between consumer processes, scheduler processes, and producer processes to reshuffle data of a distributed column oriented RDBMS according to this disclosure. FIG. 8 illustrates an example of pipelined re-shuffling occurring between the steps 308 and 314 of FIG. 7. Communication between the consumer processes 402 and the producer processes 404 utilize one or more scheduler processes 406. The consumer processes 402 can be an embodiment of the consumer processes 302 of FIG. 7 and the producer processes 404 can be an embodiment of the producer processes 304 of FIG. 7. Pipeline reshuffling is achieved by reshuffling the intermediate results provided by the producer processes 404.

The columns are generated and materialized in any order by the producer processes 404. The columns are used as input by the consumer processes 402 in the following order: C1, C2, . . . Cn; and one column is consumed completely before the next column is used. The scheduler processes 406 communicate with the producer processes 404 and the consumer processes 402.

The pipelined re-shuffling starts from column C1 and repeats for each column, Ci, in the sequence. At 408, each consumer process 402 sends a START_RCV message to the scheduler processes 406, and then waits for the column Ci data or a DONE_RCV message from the scheduler processes 406. At 410, the scheduler processes 406 receive the START_RCV message.

At 412, the scheduler processes 406 send a START SND message to all the producer processes 404 after receiving the START_RCV messages from all the consumer processes 402. At 414, the producer processes 404 receive the START_RCV messages.

At 416, the producer processes 404, after receiving START_SND, re-shuffle data for the column Ci. At 418, each producer process 404 sends a DONE_SND message to the scheduler processes 406 when data for the column Ci is re-shuffled. At 420, the scheduler processes 406 receive the DONE_SND message.

At 422, the scheduler processes 406, after receiving the DONE_SND messages from all producer processes, send a DONE_RCV message to all consumer processes 402. At 424, the consumer processes 402 receive the DONE_SND messages.

At 426, the consumer processes 402, after receiving the DONE_RCV messages from the scheduler processes 406, move to re-shuffle the next column if any. Otherwise, the re-shuffling processing is concluded.

FIG. 9 illustrates a logical diagram of a parallel/distributed shared-nothing architecture at 90. An interconnect network 92 is configured to connect to multiple nodes, or multiple servers, 94. It is a shared-nothing architecture because each node 94 has its own processor 96, main memory 98, and data storage 100. In this architecture, each processor 96 is in charge of its local memory access and the data residing in its local storage 100. The processors 96 on different nodes 94 do not share data. Because it is shared-nothing architecture, data shuffle is needed before performing a database join operation when the join columns are not the partition columns, such as disclosed in this disclosure.

Many database professionals use the terms “parallel database system” and “distributed database system” interchangeably. One needs to see the context to know whether or not it is a geographically distributed system. In this disclosure, the data records are horizontally distributed among multiple nodes/servers 94.

A table having columns of data is horizontally partitioned on a set of nodes/servers 94. In each server 94, the data records are saved column-by-column, and is called a column store. It is different from a row store which saves data record by record (or row-by-row).

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. A method for pipelined re-shuffling data of a distributed column oriented relational database management system (RDBMS), the method comprising:
receiving a request from a consumer process that requires RDBMS column data to be shuffled in a specific order according to an order that each of a plurality of columns will be used by the consumer process;
for each of the plurality of columns, re-shuffling the RDBMS column data according to the specific order to form re-shuffled RDBMS column data; and
sending the re-shuffled RDBMS column data to the consumer process.

2. The method as specified in claim 1, further comprising re-shuffling the RDBMS columns one at a time according to a sequence they are needed by the consumer process.

3. The method as specified in claim 2, wherein intermediate data is not materialized before being used by the consumer process.

4. The method as specified in claim 3, wherein the plurality of columns are distributed across one or more servers.

5. The method as specified in claim 2, wherein column data of the plurality of columns include one or more different types and categories.

6. The method as specified in claim 5, wherein the column data includes strings of names, integer identifiers, and floating point numerical data.

7. A method of communicating between a parallel consumer process and a parallel producer process of a distributed column oriented relational database management system (RDBMS), the method comprising:
receiving, by the parallel consumer process, a column operator that operates over one or more columns of RDBMS column data;
sending, by the parallel consumer process, a request to the parallel producer process for columns required by the column operator, wherein the request includes an order that the columns are present in the column operator;
processing, by the parallel producer process, the request by retrieving the columns from the RDMBS and shuffling the columns in the order that the columns are present in the column operator;
transmitting, by the parallel producer process, the columns that have been shuffled according to the order of the column operator; and
receiving, by the parallel consumer process, the shuffled columns.

8. The method as specified in claim 7, further comprising:
executing, by the parallel consumer process, column operators and consuming the column data of the shuffled columns produced by the parallel producer process.

9. The method as specified in claim 7, wherein the request requires a first column prior to a second column, wherein the parallel producer process shuffles the column data of the first column retrieved from the distributed column oriented RDBMS, and then reshuffles the column data again via the second column.

10. The method as specified in claim 8, wherein intermediate data is not materialized before being consumed by the parallel consumer process.

11. The method as specified in claim 7, wherein the columns are distributed across one or more servers.

12. The method as specified in claim 7, wherein column data of the columns include one or more different types and categories.

13. The method as specified in claim 7, wherein the column data includes strings of names, integer identifiers, and floating point numerical data.

14. A distributed column oriented relational database management system (RDBMS), comprising:
a parallel consumer process configured to receive a column operator that operates over one or more columns of RDBMS column data, and send a request indicating columns required by the column operator, wherein the request includes an order that the columns are present in the column operator; and
a parallel producer process configured to receive the request and retrieve the columns and shuffle the columns in the order that the columns are present in the column operator, and transmit the columns to the parallel consumer process that have been shuffled according to the order of the column operator.

15. The RDBMS as specified in claim 14, wherein the parallel consumer process is configured to consume the column data of the shuffled columns produced by the parallel producer process.

16. The RDBMS as specified in claim 15, wherein the request identifies a first column required prior to a second column, wherein the parallel producer process is configured to shuffle the retrieved column data of the first column, and then reshuffle the column data again via the second column.

17. The RDBMS as specified in claim 15, wherein intermediate data is not materialized before being consumed by the parallel consumer process.

18. The RDBMS as specified in claim 14, wherein the columns are distributed across one or more servers.

19. The RDBMS as specified in claim 14, wherein column data of the columns include one or more different types and categories.

20. The RDBMS as specified in claim 14, wherein the column data includes strings of names, integer identifiers, and floating point numerical data.
